(19) United States
(12) Patent Application Publication
(10) Pub. No.: US 2026/0205262 A1
(43) Pub. Date: Jul. 16, 2026

(54) SYSTEM AND METHOD FOR SECURING STREAMS

(71) Applicant: SAFRAN ELECTRONICS & DEFENSE, Paris (FR)

(72) Inventors: Louis-Theophile THIRION, Moissy-Cramayel (FR); Joseph ADELAIDE, Moissy-Cramayel (FR); Denis Jules Charles DELVILLE, Moissy-Cramayel (FR); Nicolas PELISSIER, Moissy-Cramayel (FR)

(73) Assignee: SAFRAN ELECTRONICS & DEFENSE, Paris (FR)

(21) Appl. No.: 19/448,589

(22) Filed: Jan. 14, 2026

(30) Foreign Application Priority Data
Jan. 15, 2025 (FR) 2500391

(51) Int. Cl. H04L 9/06; H04L 9/32

(52) U.S. Cl. CPC H04L 9/0618; H04L 9/065; H04L 9/32

(57) ABSTRACT

Method and system for securing data of upload streams to an onboard electronic control unit receiving data coming from a plurality of external terminals, implementing the following successive steps: obfuscating data, transmitted by an external terminal of the plurality of external terminals to a processing device via the onboard electronic control unit, such as to render them, at least in part, uninterpretable by the onboard electronic control unit; processing the data, by the processing device, including removing the obfuscating of the previously-obfuscated data and verifying the integrity of the data; transmitting the verified data to the onboard electronic control unit.

### CROSS-REFERENCE TO RELATED APPLICATION

This patent application claims the benefit of priority to French Application No. 2500391, filed on Jan. 15, 2025, the entirety of which is incorporated herein by reference.

### TECHNICAL FIELD

This description relates to the securing of communication streams, particularly upload streams to an electronic control unit onboard an aircraft, for example to electronic control units for assisting with maintenance.

### PRIOR ART

In the aeronautical field, particular attention is paid to onboard electronic control units, for which the securing of the streams is subject to particular protection standards, such as those described in the documents RTCA/Eurocae “DO-326A/ED-202A: Airworthiness Security Process Specification” and “DO-356A/ED-203A: Airworthiness Security Methods and Considerations”.

Onboard electronic control units require ever more connections to make it possible to access a constantly increasing amount of information conventionally coming from various sources. However, the architectures of known electronic control units are unfortunately not dimensioned to ensure the security of all the upload streams of the desired connections.

This is because the architectures of onboard electronic control units have not been developed in such a way as to easily allow the securing of new upload streams. In other words, provision has not been made for means for receiving streams from various sources securely by said electronic control unit. This problem particularly arises when modernizations are made to old models of aircraft. However, due, among other things, to the constantly increasing use of data, new exchange channels have been introduced between said onboard electronic control unit and external devices. The reliability, not only of the external devices but also of the exchange channels, is unknown, these devices and channels being able to be the target of malicious attacks which might intercept and possibly compromise the exchanged data.

To be able to ensure the security levels required in the standards for all upload streams, and where applicable download streams, it is therefore necessary to upgrade the architectures of onboard electronic control units to comply with these standards.

Conventionally, full-level cyber gateways, controlling the security of the streams for each upload stream input to the electronic control unit, are added.

However, these gateways are expensive, bulky and costly in computational terms. Increasing the number of these gateways so as to have a gateway for each input of an onboard electronic control unit is therefore not desirable.

An alternative solution can be to make all or part of the incoming streams converge on one and the same input, this input being secured by a full-level cybersecurity gateway. Such an architecture does however require significant modifications of the wiring of the inputs of the onboard electronic control unit to render them converge on said secure input. This alternative solution requires, inter alia, an increase in the number of cables as well as their possible extension, and more generally an increase in the weight of all the necessary cables, weighing down and encumbering the aircraft. This is not desirable.

In addition, to be able to ensure the required security levels, the architecture modifications may affect sub-systems of third-party definition and property. This would therefore involve modifications of proprietary codes or access to the documentation of rival systems. These scenarios are generally impossible.

There is therefore a real need to allow the securing of upload streams to an onboard electronic control unit in a way that is free, at least in part, of the drawbacks inherent to the solutions described previously.

### SUMMARY OF THE INVENTION

The present disclosure relates to a method for securing data of upload streams to an onboard electronic control unit receiving data coming from a plurality of external terminals, the method including the following successive steps:
a. Obfuscating data, transmitted by an external terminal of the plurality of external terminals to a processing device via the onboard electronic control unit, such as to render them, at least in part, uninterpretable by the onboard electronic control unit;
b. Processing the data, by the processing device, including removing the obfuscation of said previously-obfuscated data and verifying the integrity of the data;
c. Transmitting the verified data to the onboard electronic control unit.

The method according to the invention thus makes it possible, by a particular routing of the streams, to secure, at a given security level, all the upload streams to an onboard electronic control unit coming from a multitude of external terminals, while requiring only a single processing device complying with the given security level.

The onboard electronic control unit, within the meaning of the invention, is distinguished from the external terminals by its higher security level. Subsequently the onboard electronic control unit is interchangeably known as “onboard electronic control unit”, or “onboard electronic control unit of a higher security level”. The onboard electronic control unit is for example subject to more restrictive standards than the external terminals. Additionally or alternatively, in embodiments of the invention, the security level of the external terminals is unknown, and is therefore considered as being lower by default.

The obfuscation of the data allows the conveyance of the data via the onboard electronic control unit without risk, while limiting the computational requirements and complexity of processing. The fact of rendering the data uninterpretable by said electronic control unit advantageously allows this latter to transmit the data to the processing device while ensuring the security of the onboard electronic control unit and does so in a relatively simple manner.

The term “data uninterpretable by the onboard electronic control unit” should be understood to mean that the electronic control unit does not know how to interpret the content of the data, in other words it can understand neither the syntax nor the content of the data payload. Thus, the onboard electronic control unit only receives then transmits the obfuscated data.

Correspondingly, the invention relates to a system for securing upload stream data to an onboard electronic control unit, configured to implement a method according to the invention, the system including:
a processing device intended to be connected between a first external terminal and said onboard electronic control unit, and
at least one obfuscating device intended to be connected between at least a second external terminal and said onboard electronic control unit,
the processing device supplying a security level of the streams higher than the security level of the streams of the obfuscating device,
the obfuscating device being configured to: receive data from the second external terminal to which it is connected; obfuscate, at least in part, data so as to render them uninterpretable by the onboard electronic control unit; transmit said data to the onboard electronic control unit,
the processing device being configured to: receive data from the onboard electronic control unit previously obfuscated by the obfuscating device; deobfuscate said obfuscated data; transmit the data to the onboard electronic control unit after verifying the integrity of the data.

Such a system can be easily deployed. In particular, it is easily adapted to the constant increase in the number of upload streams. Thus, it is possible to add new inputs to the onboard electronic control units without this requiring any significant modification of architecture.

One security level of the streams is said to be higher than another when it makes it possible to more reliably confirm the integrity of a data stream and/or of a terminal. Thus, one security level of the streams can be higher than another when more verifications and/or more complex verifications with the aim of confirming the integrity of the data of the streams and/or the integrity of the terminal having transmitted said data are carried out. In other words, the verification of a data stream of a higher security level is stronger by comparison with a verification of a data stream of a lower security level.

The processing and/or obfuscating device may be chosen from among:
a cybersecurity gateway, in particular an SWG (Secure Web Gateway),
a computing device, for example of ADLU type; such a computing device of ADLU type intended to update data for computer devices is described in the patent application WO202105044,
a computer program comprising code instructions which, when implemented, make it possible to implement the steps relating to the devices.

The processing and/or obfuscating device may take the form of a FPGA, a CPU, a microcontroller.

The processing and/or obfuscating devices may be advantageously included in existing devices.

The processing device preferably includes a full-level cybersecurity gateway.

The processing device is in particular configured to carry out a filtering of all the protocol layers, OSI in the context of an Ethernet stream, of the data streams.

The obfuscating device may be a secure web gateway.

The term “obfuscating” should be understood to mean any conventionally-used method for masking the interpretation of all or part of the data.

The obfuscation implemented in the method according to the invention is reversible. In other words, based on the obfuscated data, it is possible to retrieve the initial data without alteration of these latters, conditional on the knowledge of a key or of an algorithm making it possible to reverse the obfuscation, in other words to deobfuscate the obfuscated data. In particular, the obfuscation of the data may include a scrambling of the data and/or an encryption of the data.

The method may include the prior determination of an encryption and/or scrambling protocol, particularly a scrambling key. In particular, this encryption and/or scrambling protocol is known and common to the processing and obfuscating devices, and makes it possible to perform the steps of obfuscating and deobfuscating the data.

In particular, the obfuscating of the data can be a block cipher mechanism or stream cipher mechanism generating a pseudo-random stream obtained based on the initial data stream to be obfuscated and on a obfuscating key.

Preferably, the obfuscating is a scrambling of at least a portion of the data.

Preferably, the processing and obfuscating devices are configured so as to be able to perform the two operations of obfuscating and deobfuscating.

Thus, in particular embodiments, the processing device is further configured to:
receive, from the first external terminal, data addressed to the second external terminal to which the processing device is connected;
obfuscate, at least in part, said data so as to render them uninterpretable by the onboard electronic control unit of higher security level;
transmit said data to the onboard electronic control unit of high security level; and the obfuscating device is configured to:
deobfuscate obfuscated data received and addressed to the second external terminal to which it is connected.

This advantageously allows for efficient communication between a first external terminal and a second external terminal, by making use of the existing connections through an onboard system, via at least one onboard electronic control unit of higher security level, and does so while ensuring the security of the onboard system against malicious attacks. In other words, this makes it possible to convey data for which a given level of cybersecurity cannot be entirely guaranteed, via onboard electronic control units complying with a security level higher than or equal to the given level of cybersecurity.

The obfuscation of the data can be done solely on a part of the protocol layers of a data stream including said data, particularly on the higher-level protocol layers, for example on all the OSI protocol layers higher than or equal to 5 in the context of an Ethernet stream.

In particular embodiments, a portion of the data is not obfuscated. For example, the non-obfuscated portion could represent an integrity verification code of the obfuscated part. In this case, this portion is relatively small by comparison with the obfuscated portion of data and advantageously makes it possible to check that all the data are unaltered, particularly during the implementation of the obfuscation and the removal of the obfuscation, but also during transmissions.

All or part of the steps of the method, and in particular, the steps of obfuscating and deobfuscating, according to the invention may be implemented by computer, particularly by programmable logic in an FPGA or wired logic. Preferably, all the steps of the method are implemented by computer.

Thus, the invention also relates to a computer program comprising code instructions which, when implemented, allow the execution of the steps of the method according to the invention, this program being able to be implemented in a system according to the invention.

The invention further relates to a recording medium readable by means of a computer including a computer program according to the invention.

In particular, the computer program may be a programmable logic, the recording medium being able to include, inter alia, components of FPGA type.

The invention also relates to an electronic control unit intended to be onboard an aircraft including a system according to the invention.

The invention also relates to an aircraft including a system according to the invention. The system can advantageously be implemented in an aircraft, the processing and obfuscating devices being connected to an onboard electronic control unit of said aircraft.

The aforementioned features and advantages, as well as others, will become apparent on reading the following detailed description. This detailed description refers to the appended drawings.

### BRIEF DESCRIPTION OF THE DRAWINGS

The appended drawings are diagrams and have the aim, first and foremost, of illustrating the principles of the disclosure.

On these drawings, from one figure to the next, identical elements (or parts of elements) are identified by the same reference signs.

FIG. 1 illustrates the steps of a method for securing data according to the invention,

FIG. 2 is a diagram of an example of a system for securing data according to the invention in its environment,

FIG. 3 is a diagram of another example of a system for securing data according to the invention in its environment,

FIG. 4 is a diagram of another example of a system for securing data according to the invention in its environment, and

FIG. 5 illustrates an implementation of a obfuscation/deobfuscation in a method or system according to the invention.

### DESCRIPTION OF THE EMBODIMENTS

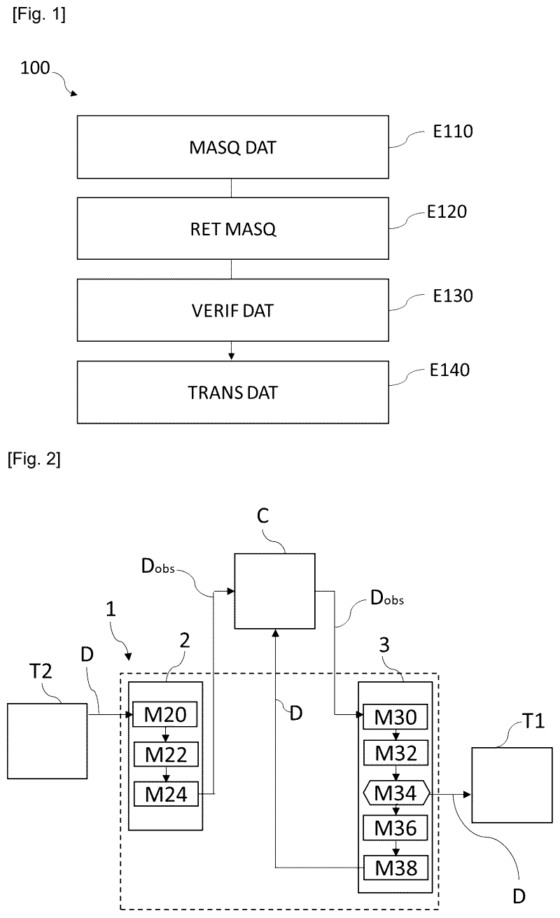

To make the disclosure more tangible, an example of a method 100 for securing upload streams of data to an onboard electronic control unit receiving data coming from a plurality of external terminals (FIG. 1) along with examples of systems 1 (FIGS. 2, 3 and 4) for implementing such a method are described in detail hereinafter, with reference to the appended drawings. It is recalled that the invention is not limited to these examples.

Each external terminal T2, T2a, T2b, T2c, T1 communicates with the onboard electronic control unit C via a processing 3 or obfuscating 2 device.

The method 100 includes a step E110 of obfuscating data, transmitted by an external terminal T2 of the plurality of external terminals communicating with said onboard electronic control unit C, a step E120, E130 of processing the data by a processing device 3, and a step E140 of transmitting the verified data to the onboard electronic control unit C.

The step E110 of obfuscating the data D can be implemented by means of a obfuscating device 2.

The obfuscating device 2 is connected between an external terminal T2 and the onboard electronic control unit C.

Preferably, a system 1 according to the invention includes a plurality of obfuscating devices 2 and a single processing device 3 for a given onboard electronic control unit C. In general, a system according to the invention preferably includes more obfuscating devices 2 than processing devices 3.

This step E110 advantageously makes it possible to obtain data D_{obs}, at least partially obfuscated, uninterpretable for the onboard electronic control unit C.

Thus, the onboard electronic control unit can neither understand nor execute the payload contained in the data D and is protected from any malicious attack.

The onboard electronic control unit can, based on these obfuscated data, only transmit them to the processing device 3.

In addition to the obfuscation of the data, a processing step can be carried out so as to impose a routing of the obfuscated data to the processing device 3 via the onboard electronic control unit.

In particular, a verification that a source IP and/or source MAC address is not that of the onboard electronic control unit C and/or the addition of a destination IP and/or destination MAC address of the processing device 3 can be carried out.

The obfuscation may include a scrambling of the data or an encryption of the data, such as a bitwise XOR or a ROT 13.

In the context of data in the form of a frame of an Ethernet stream, the obfuscation can be applied solely to certain high-level OSI layers. In particular, the obfuscation can be applied at least to the payload, or solely to the payload. For example, the obfuscation of the data can be applied solely to the OSI layers higher than or equal to 5 of the frame.

Before the obfuscation of the data, the method may include a filtering of the low-level OSI layers, for example of firewall or equivalent type, particularly the filtering of the OSI layers 2 to 4 of the frame. This step may be implemented by the obfuscating device 2.

Before the obfuscation of the data, the method may include a verification of the integrity of at least a part of the data, this verification having a relatively low security level. For example, the verification of the integrity can include the verification of a frame length in the context of an Ethernet stream. This step can be implemented by the obfuscating device 2.

The security level of the verification carried out before the obfuscation of the data is said to be relatively low by comparison with the verification of the integrity of the data subsequently carried out by the processing device 3.

Once obfuscated, the data D_{obs} are conveyed via the onboard electronic control unit C to the processing device 3.

The processing device 3 receives the obfuscated data D_{obs}, removes the obfuscation, during a step E120, so as to obtain the data D as they were before the obfuscating step. The obfuscating method used is a reversible method, with no loss of information. For example, by applying a bitwise XOR between an encryption key and the obfuscated data D_{obs}, when the data have been obfuscated by applying a bitwise XOR with said encryption key, or by applying the reverse of the ROT13 when the data have been obfuscated by applying a ROT 13.

A step E130 of verifying the integrity of the deobfuscated data D is then carried out by the processing device 3.

This verifying step is performed for a given security level. In particular, this security level corresponds to the level required to comply with the standards in effect, particularly the standards RTCA/Eurocae, DO-326A/ED-202A and DO-356A/ED203A mentioned previously. Preferably, the security level includes a SAL 2 (Security Assurance Level 2) or SAL 3 (Security Assurance Level 3) level, defining expected security properties in aeronautical systems.

The verifying step E130 may include a complete filtering of all the protocol layers. For example in the context of an Ethernet stream, the processing device can filter all the fields from the MAC physical address to the payload.

According to an embodiment, the verifying step may include the following optional steps: deconstructing the frame before proceeding to a filtering of the fields of the frame, constructing a new frame, based on the filtering of the deconstructed frame, after filtering the fields of the frame, this new frame corresponding to the data D intended to be transmitted of the onboard electronic control unit C.

The processing device 3 then sends, during a step E140, the data D to the onboard electronic control unit C, which can then interpret these data D.

FIG. 2 is a diagram of the processing of a data stream D by a system 1 for securing upload stream data to an onboard electronic control unit according to the invention.

The system 1 includes a processing device 3 connected between a first external terminal T1 and the onboard electronic control unit C, and a obfuscating device 2 connected between a second external terminal T2 and said onboard electronic control unit C.

The data D are transmitted by the second external terminal T2 to the obfuscating device 2.

The obfuscating device 2 may include:
a module M20 for receiving data coming from the second external terminal T2,
a processing module M22 configured, inter alia, to obfuscate, in other words to obscure, and where applicable deobfuscate, in other words un-obscure, the data D, and
a module M24 for transmitting the obfuscated data to the onboard electronic control unit C.

The processing device 3 may include:
a module M30 for receiving obfuscated data D_{obs} coming from the onboard electronic control unit C,
a processing module M32 configured, inter alia, to deobfuscate, and where applicable obfuscate, the data D_{obs},
optionally a module M34 for managing the orientation of the data streams configured to transmit the data D to an external terminal, particularly the first external terminal T1 in communication with the processing device 3,
a module M36 for verifying the integrity of the data, and
a module M38 for transmitting the data to the onboard electronic control unit C.

The processing device 3 and the obfuscating device 2 may share an obfuscating key so as to allow the reversal of the obfuscation of the data.

The obfuscating key can be:
generated by a known algorithm, known by the processing and obfuscating devices,
contained in a storage table accessible to the processing and obfuscating devices,
generated by the processing device and the obfuscating device, a part of the key being able to be generated by the processing device, a complementary part by the obfuscating device, said parts being transmitted securely so as to allow each of the processing and obfuscating devices to form the key, or
generated randomly then transmitted to at least one of the processing and obfuscating devices, for example by being:
generated by the obfuscating device and transmitted securely to the processing device,
generated by the processing device and transmitted securely to the obfuscating device,
generated by another device and transmitted to the processing and obfuscating devices.

Preferably, an obfuscating key is generated for a data stream or a frame.

In particular embodiments, the obfuscating key is generated by means of a cryptographic function implementing a random number generator capable of producing a sequence of random bits. This type of well-known function is designed to guarantee the uniqueness, unpredictability and security of the keys generated.

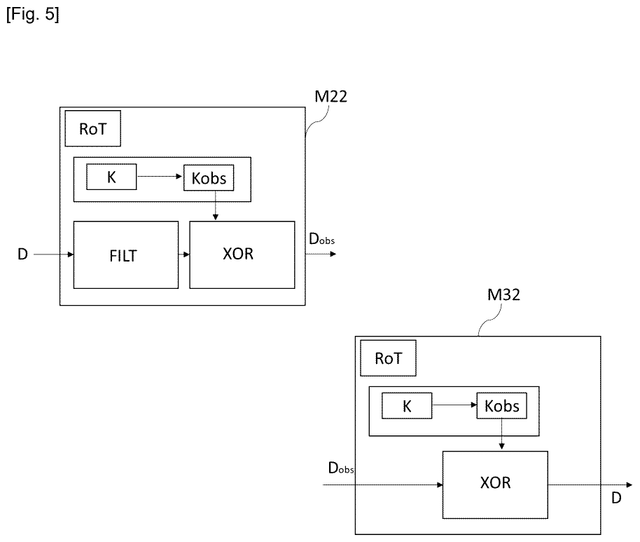

FIG. 5 illustrates an exemplary embodiment of the obfuscating and deobfuscating steps implemented by the processing modules M22, M32 of the obfuscating 2 and processing 3 devices.

The modules M22 and M32 preferably include an RoT, Root of Trust. It should be noted that the root of trust may consist of software elements but it is preferably implemented in the form of a hardware module. The root of trust provides services for securing the processing modules M22, M32, and optionally the processing 3 and obfuscating 2 devices. In particular, the root of trust is used to store and protect private/public key pairs, authentication certificates, these keys and certificates not being able to be used by other modules/devices without this root of trust.

In particular embodiments, the processing modules share a secret key K, for example by application of an EAP-TLS exchange protocol, a derivative of this protocol, or any equivalent protocol.

Each module generates a derivative K_{obs} of this secret key, thus forming the obfuscating key.

The obfuscating key can be generated for each new stream, or even for each frame of a stream. Such a derivative of the secret key advantageously makes it possible to improve the cryptographic security of the encryption.

The derivative K_{obs} can in particular be obtained from a root key which is never used to encrypt the data stream. The derivative is preferably generated for each new stream, or each new stream frame, thus limiting its lifetime which makes it possible to reduce exposure to attacks.

The derivative may be formed by each of the modules by applying one and the same algorithm shared by said modules. Said algorithm is for example based on a cryptographic function of HMAC type which expects, as input, the concatenation of the root key and a unique number usable a single time and known by each of the modules. The unique number may be obtained from a counter, from a time base. Alternatively, the obfuscating key may be generated by a device separate from the processing and obfuscating devices, not shown here, this separate device transmitting said obfuscating key to the processing and obfuscating devices.

A first filtering can be applied to the data D, for example so as to filter the low layers of an Ethernet frame, for example the OSI layers 2 to 4, then an encryption method, for example of XOR type, is applied at least to the payload of the data. A part of the payload may be excluded from the obfuscation forming an integrity pattern, this integrity pattern being subsequently exploited by the processing device during the verification of the integrity of the data D. The obfuscated data may thus contain an non-obfuscated part.

A method making it possible to invert the encryption method applied to the data D is then applied to the obfuscated data D_{obs}.

The data may optionally be transmitted by the processing device 3 to an external terminal, for example to the first external terminal T1, after having been deobfuscated, without having been submitted to the module M36 for verifying the integrity of the data, preferably they are not submitted. This advantageously allows the transmission of data between external terminals efficiently without endangering the security of the onboard electronic control unit.

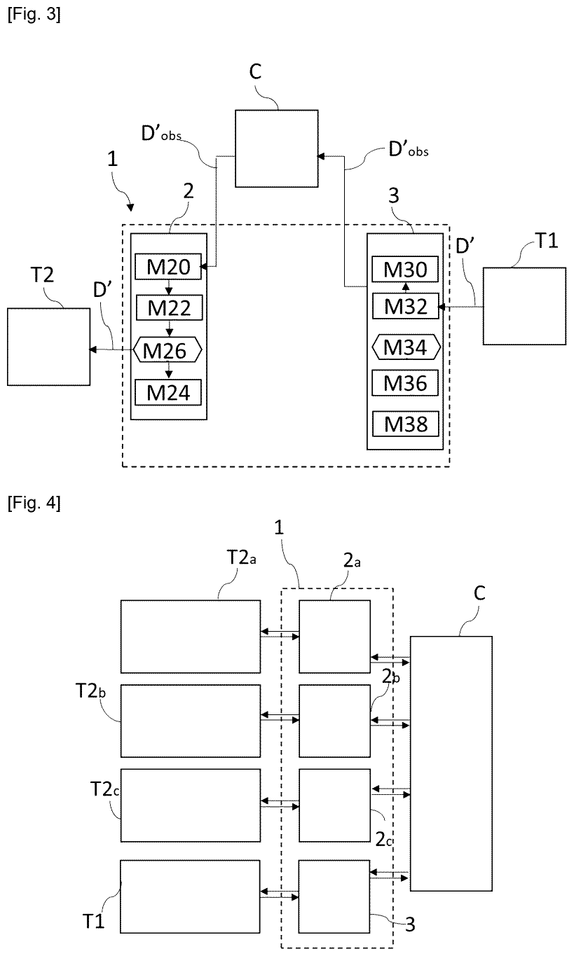

In particular embodiments, the processing module M32 is further configured to obfuscate data D′ transmitted by the first external terminal T1 to the processing device 3, and the processing module M22 is moreover configured to deobfuscate the data D′_{obs} resulting from the obfuscation of the data D′ by the processing module M32 and transmitted via the onboard electronic control unit C, the obfuscating device 2 including a module M26 for managing the orientation of the data streams configured to transmit the data D′ to an external terminal, particularly the second external terminal T2 in communication with the obfuscating device 2. Such an example of a system 1 according to the invention is shown in FIG. 3. There again, this advantageously allows the transmission of data between external terminals efficiently without endangering the security of the onboard electronic control unit.

A system 1 according to the invention may include several obfuscating devices and a single processing device. An example of a system including three obfuscating devices 2ₐ, 2_{b}, 2_{c}, each connected to an external terminal T2ₐ, T2_{b}, T2_{c}, respectively, is shown on FIG. 4.

The addition of an input to an onboard electronic control unit may moreover be done efficiently and with no particular difficulty by the addition of a obfuscating device at this input.

The processing device requires greater and more complex computational resources than the obfuscating devices. However, as will be clearly apparent on reading the preceding description, the system according to the invention only requires the presence of one processing device which makes it possible to ensure the required security level by verifying the integrity of the data of all the inputs in communication with the onboard electronic control unit. Thus, the integrity of the data may be ensured for a predefined security level, and corresponding to the security level applied by the processing device, while limiting the necessary computational resources. Moreover, the implementation of the system is particularly rapid and easy to implement. Moreover, the invention can advantageously be implemented in real time.

Although this invention has been described with reference to specific exemplary embodiments, it is obvious that modifications and changes may be made to these examples without departing from the general scope of the invention as defined by the claims. In particular, individual features of the different embodiments illustrated/mentioned may be combined into additional embodiments. Consequently, the description and the drawings may be considered in an illustrative sense rather than a restrictive one.

It is equally obvious that all the features described with reference to the method are transposable, alone or in combination, to the system, and conversely, all the features described with reference to the system are transposable, alone or in combination, to the method.

What is claimed is:

1. A method for securing data of upload streams to an onboard electronic control unit receiving data coming from a plurality of external terminals, the method including the following successive steps:
a. Obfuscating data, transmitted by an external terminal of the plurality of external terminals to a processing device via the onboard electronic control unit, such as to render them, at least in part, uninterpretable by the onboard electronic control unit;
b. Processing the data, by the processing device, including removing the obfuscation of said previously-obfuscated data and verifying the integrity of the data;
c. Transmitting the verified data to the onboard electronic control unit.

2. The method as claimed in claim 1, the obfuscation of the data including: a scrambling of the data or an encryption of the data.

3. The method as claimed in claim 2 wherein the encryption of the data can be a block cipher mechanism or stream cipher mechanism generating a pseudo-random stream obtained based on the initial data stream to be obfuscated and on a obfuscating key.

4. The method as claimed in claim 1 wherein the verifying of the integrity of the data includes a filtering of all the protocol layers of a data stream including said data.

5. The method as claimed in claim 1 wherein the data obfuscating is done solely on a part of the protocol layers of a data stream including said data.

6. The method as claimed in claim 1 wherein a portion of the data is not obfuscated.

7. A system for securing upload stream data to an onboard electronic control unit, configured to implement a method as claimed in claim 1, the system including:
a processing device intended to be connected between a first external terminal and said onboard electronic control unit, and
at least one obfuscating device intended to be connected between at least a second external terminal and said onboard electronic control unit, the processing device supplying a security level of the streams higher than the security level of the streams of the obfuscating device,
the obfuscating device being configured to: receive data from the second external terminal to which it is connected; obfuscate, at least in part, data so as to render them uninterpretable by the onboard electronic control unit; transmit said data to the onboard electronic control unit,
the processing device being configured to: receive data from the onboard electronic control unit previously obfuscated by the obfuscating device; deobfuscate said obfuscated data; transmit the data to the onboard electronic control unit after verifying the integrity of the data.

8. The system as claimed in claim 7, the processing device being further configured to: receive, from the first external terminal, data addressed to the second external terminal to which it is connected; obfuscate, at least in part, said data so as to render them uninterpretable by the onboard electronic control unit; transmit said data to the onboard electronic control unit; the obfuscating device being configured to deobfuscate obfuscated data, received and addressed to the obfuscating device to which it is connected.

9. An aircraft including a system as claimed in claim 1.
